(19) United States
(12) Patent Application Publication
(10) Pub. No.: US 2016/0324168 A1
(43) Pub. Date: Nov. 10, 2016

(54) Edible Structure Interior Pop-up Assembly

(71) Applicant: Jason May, Peoria, AZ (US)

(72) Inventor: Jason May, Phoenix, AZ (US)

(21) Appl. No.: 14/948,358

(22) Filed: Nov. 22, 2015

Related U.S. Application Data
(60) Provisional application No. 62/156,735, filed on May 4, 2015.

(51) Int. Cl. A21D 13/00; A63F 9/00; A23G 3/56

(52) U.S. Cl. CPC A21D 13/009; A23G 3/566; A63F 9/001; A63F 2009/0033

(57) ABSTRACT

The present invention is a flexible interior support which allows edible structures to lay in a flatten state during storage and then pop-up to stand upright prior to use. A method for making the pop-up decorative edible structure is also presented. The pop-up interior support is preferably used in the construction of arts and crafts, and more specifically the construction of decorative edible structures, such as gingerbread houses.

### CROSS-REFERENCE TO RELATED APPLICATIONS

This application is a Continuation In-Part of, and claims priority from, U.S. Application Ser. No. 62/156,735 filed on May 4, 2015.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to the construction of arts and crafts, and more specifically the construction of decorative edible structures, such as gingerbread houses and methods of assembling the same.

### BACKGROUND OF THE INVENTION

Decorating edible structures, such as gingerbread houses have been a popular holiday and celebratory past time for generations. The gingerbread house has roots going back to eleventh century. A variety of models exist, such as Chuang (U.S. Pat. D465,314S and D453,123S), Brown (U.S. Pat. D314,854S) and Chui (U.S. Pat. D378,286S). Further, various methods of assembly have been developed, such as Madonia (U.S. Pat. No. 8,403,722 B2), Babos (U.S. Pat. No. 4,431,395), and Kolz (U.S. Pat. No. 7,210,920 B2).

In each adaptation one large problem still exists for the adult and/or child, assembly. While decorating is the most enjoyable part of the decorative edible structures experience, assembly is the most frustrating. Whether holding the walls up with multiple hands, placing walls in a horizontal base, or attempting to interlock various pieces assembly is time consuming, often leads to collapse, and inconsistent experiences. Systems like the raised tray (U.S. Pat. No. 8,403,722 B2) limit the child and adult end-user's creativity by dictating the location of the structure and designating yard space among other factors. Further, assembly requires drying time of the structural binding agent, typically icing. Prior to decorating, end-users must patiently wait for the icing to dry or risk structural collapse. Solutions like the interlocking gingerbread involve even greater assembly time as assembly requires careful attachment of each panel, and waste in unused baked remains.

The most common solution to the assembly problem has been for manufactures to fully assemble the structure in a similar fashion as the end-user: holding walls together while applying frosting and waiting for the frosting to dry. Then, ship the fully assembled structure in a very large container. This method is very costly and inefficient as factors like shipping and storage space of a pre-assembled structure takes many times the area as their un-assembled counterparts. Further, these pre-assembled structures have a tendency to break or fall apart during the lengthy shipping process resulting in wasteful returns or need for reassembly.

An object of the present invention is to provide an assembly system that will permit the structure to stand without need of the end user wall or roof assembly.

Another object of the present invention is to provide a mode to bring the benefits of an assembled structure to the end-user. Similarly this mode will retain the benefits of a non-assembled structure for the manufacture. Thus, reducing factors such as the shipping and storage footprint of pre-assembled edible structures and therefore the cost, by allowing the the structure to ship and store in a flattened state prior to decoration.

### SUMMARY OF THE INVENTION

In a preferred embodiment the present invention provides an edible structure pop-up assembly that removes the hassle of wall and roof assembly for the end-user and a more cost effective manufacturing method by reducing shipping and storing costs. The apparatus for assembling is comprised of at least one interior pop-up support which is affixed to the exterior edible elements of the structure, such as the walls and/or roof of a gingerbread house.

### BRIEF DESCRIPTION OF THE DRAWING

The accompanying drawings illustrate a preferred embodiment of the invention according to the best modes so far devised for the practical application of the principals therefore are not to be considered as limiting its scope with regard to other embodiments which the invention is capable of contemplating. Accordingly:

FIG. 1 is a topside perspective view of the pop-up interior support, and variations thereof.

FIG. 2 is a perspective view of vertically extending wall, and roof elements being prepared for assembly to the pop-up interior support.

FIG. 3 is a perspective view of the vertical extending wall and roof elements affixed to the pop-up interior support laid flat or in a horizontal position.

FIG. 4 is a perspective view of the vertical extending wall and roof elements affixed to the pop-up interior support in an upright position.

### DETAILED DESCRIPTION OF THE INVENTION

In general, the kit of the present invention comprises of at least one pop-up interior support which edible material is affixed. The number, size, and style of the interior support may vary in each kit depending on the edible structure being created. Although figures depict the structure of a house, it is understood that other structures such as gingerbread houses; aquatic vessels; vehicles; gift boxes; baskets; trains; commercial, residential, industrial buildings to name a few are also included in this invention. The most preferred embodiment of the structure is a house or building.

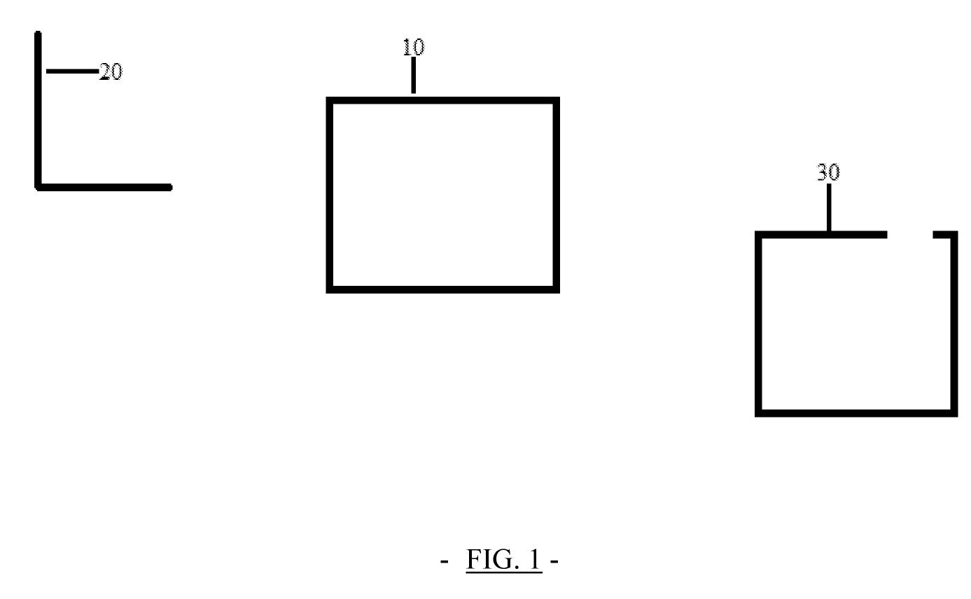

FIG. 1 depicts the embodiment of the present invention and variations therein prior to assembly in the kit, showing a top view of a full perimeter pop-up interior support (10), a corner or roof pop-up interior support (20) and a partial perimeter pop-up interior support (30) in a standing position. Dimensions of the pop-up interior support will vary depending on factors such as the size of the edible structure, weight to be supported by the pop-up, or materials used in the structure. The pop-up interior support may be an unbroken continuous unit (10) or may have ends with breaks/ space between ends (30, 20). It is understood to one of ordinary skill in the art that the pop-up interior support (10, 20, 30) may further include at least one locking support (not shown) to secure the desired degree of angle of each corner of the edible structure. The locking support will be more ridged than the pop-up interior support and applied generally in the corner(s) of the structure.

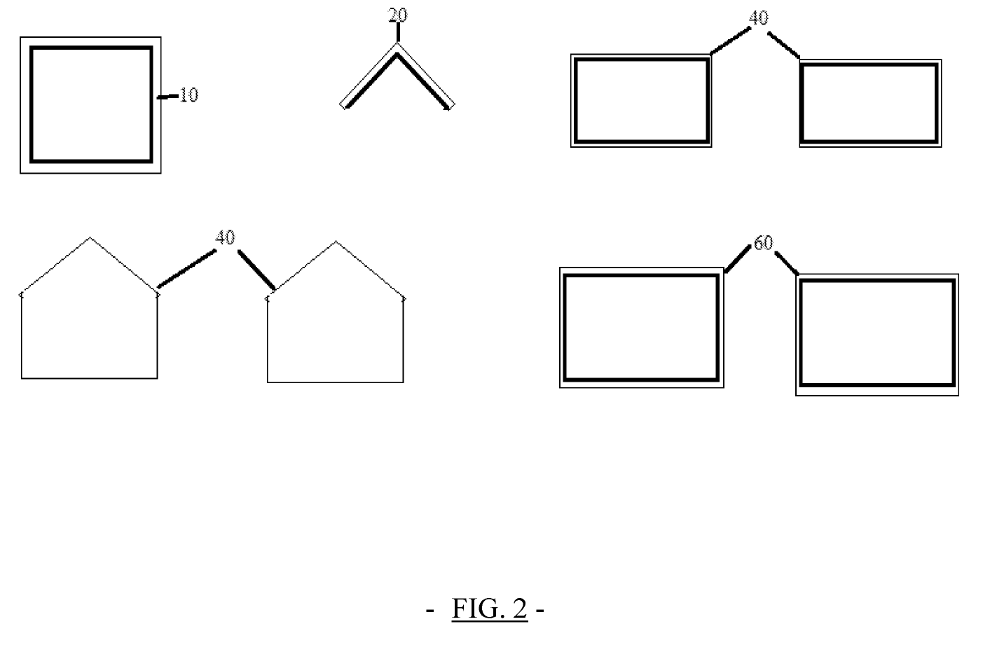

Referring to FIG. 2 depicts the remaining elements of the kit prior to assembly: full perimeter pop-up interior support (10); roof pop-up interior support (20); edible walls (40); and edible roof panels (60). The walls (40) and roof panels (60) are then affixed to the accompanying pop-up interior supports (10, 20). It is understood to one of ordinary skill in the art that affixing maybe done by adhesion, bonding, or anchoring.

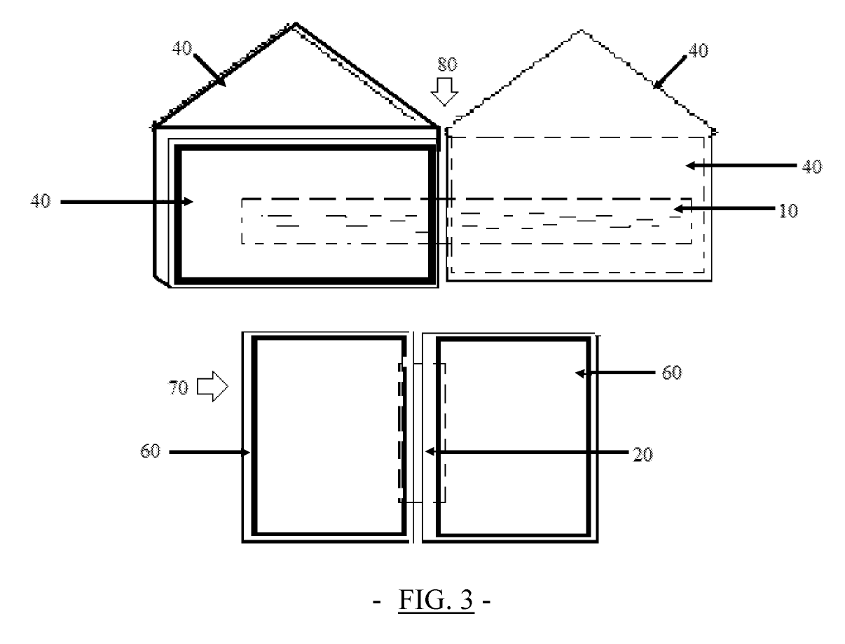

Referring to FIG. 3 depicts the preferred embodiment of the assembled elements of the kit in a flattened state. The roof assembly (70) comprising of roof pop-up interior support (20) and roof panels (60) lay open where each panel lays end to end or closed (not shown) where each panel lay on top of each other. The wall assembly (80) comprising of walls (40) and pop-up interior support (10) lay in a flattened state where the edible walls (40) lay adjacent and/or on top of each other with the pop-up interior support (10) between the top and bottom layer of walls (40). It is understood to one of ordinary skill in the art that although a full perimeter pop-up interior support is depicted in this embodiment other of the variations of the pop-up interior support not shown also apply under this invention.

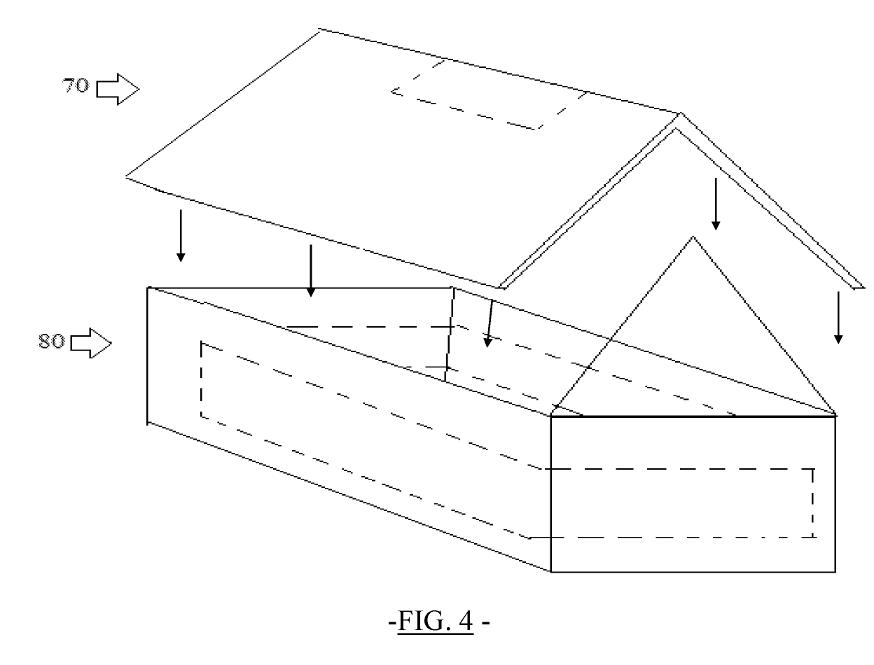

Referring to FIG. 4 depicts the preferred embodiment of the assembled elements of the kit in an upright position. The upright wall assembly (80) is placed by the end-user in any desired location, angle, or environment; usually on some type of movable base like a sheet of cardboard. Since, the edible structure is not limited to a predetermined location the options are limited only by the end-user's imagination. The roof assembly (70) is then placed on top of the wall assembly (80). The end-user may affix (70) to (80) or leave unfastened for interior access to the edible structure either way the edible structure is ready for decoration.

I claim:

1. A kit for assembling pop-up decorative edible structures comprising,
at least one pop-up interior support and at least one exterior edible structural element.

2. A kit in claim 1 wherein the said pop-up interior support is comprised of edible, organic inedible, inorganic, or combination of materials.

3. A kit in claim 1 wherein each of the said pop-up interior supports are affixed to edible exterior structural elements.

4. A kit in claim 2 wherein the said pop-up interior support is flexible allowing for the structure to fold into a flattened position and unfold to an upright position.

5. A kit in claim 2 wherein the said pop-up interior support is comprised of a semi-ridged material.

6. A kit in claim 2 wherein the said pop-up interior support is comprised of a corrugated material.

7. A kit in claim 1 wherein the said edible structural element is a cooked material.

8. A kit in claim 7 wherein the said edible structural element is a doughy material.

9. A kit in claim 8 wherein the said doughy material is gingerbread dough.

10. A method of making a pop-up decorative edible structure using a pop-up interior support comprising of the steps of:
a) Providing a pop-up interior support;
b) Providing a doughy material or instructions to make and bake the same;
c) Providing a material to affix the edible structural elements to the pop-up interior support, or instructions to make the same.
